(19) United States
(12) Patent Application Publication
(10) Pub. No.: US 2012/0194454 A1
(43) Pub. Date: Aug. 2, 2012

(54) FINGER TILT DETECTION IN TOUCH SURFACE-BASED INPUT DEVICES

(75) Inventors: Ilan Margalit, Tel-Aviv (IL); Ziv Hershman, Givat Shmuel (IL); Einat Nosovitsky, Herzliya (IL)

(73) Assignee: NUVOTON TECHNOLOGY CORPORATION, Hsin-chu (TW)

(21) Appl. No.: 13/345,718

(22) Filed: Jan. 8, 2012

Related U.S. Application Data
(60) Provisional application No. 61/438,269, filed on Feb. 1, 2011.

(51) Int. Cl. G06F 3/041

(52) U.S. Cl. 345/173; 178/18.03

(57) ABSTRACT

An input device includes a touch sensor and a processing unit. The touch sensor has a surface and is configured to sense an imprint of a finger that touches the surface. The processing unit is configured to calculate a tilt of the finger relative to the surface by measuring a shift of the imprint sensed by the touch surface, and to produce an output based on the tilt.

### CROSS-REFERENCE TO RELATED APPLICATIONS

This application claims the benefit of U.S. Provisional Patent Application 61/438,269, filed Feb. 1, 2011, whose disclosure is incorporated herein by reference.

### FIELD OF THE INVENTION

The present invention relates generally to input devices for data processing systems, and particularly to pointing devices based on finger tilt detection.

### BACKGROUND OF THE INVENTION

Systems requiring user input, such as personal computers, incorporate various kinds of human interface devices for accepting the user input. Such input devices comprise, for example, mouse and track point devices, as well as touch pads. For example, U.S. Pat. No. 6,115,030, whose disclosure is incorporated herein by reference, describes a track point device comprising a capacitive sensor input device, which includes a movable stud having a having a top portion for manipulation by a user and a conductive bottom portion, which is connected to a planar surface. A plurality of sensors is disposed on the planar surface. The respective capacitances between the conductive bottom portion and respective ones of the sensors are used as input to another electronic device, such as a computer, set top box or gaming device. As the capacitances change according to user manipulation of the movable stud, elements of the user interface are moved accordingly.

U.S. Pat. No. 7,057,603, whose disclosure is incorporated herein by reference, describes a notebook computer force-controlled pointing stick device incorporating a cap with enhanced ergonomic features.

U.S. Pat. No. 6,408,087, whose disclosure is incorporated herein by reference, describes a capacitive semiconductor user input device. The system controls the position of a pointer on a display by detecting motion of ridges and pores of a fingerprint of a user and moving the pointer on the display according to detected motion of the ridges and pores of the fingerprint. The system captures successive images of the fingerprint ridges and pores and detects motion of the ridges and pores based upon the captured successive images.

### SUMMARY OF THE INVENTION

An input device includes a touch sensor and a processing unit. The touch sensor has a surface and is configured to sense an imprint of a finger that touches the surface. The processing unit is configured to calculate a tilt of the finger relative to the surface by measuring a shift of the imprint sensed by the touch surface, and to produce an output based on the tilt.

In some embodiments, the processing unit is configured to measure the shift in the imprint between a first time at which the finger initially touches the surface and a second time that is subsequent to the first time. In an embodiment, the processing unit is configured to measure the shift in the imprint by measuring a displacement of a center of the imprint.

In a disclosed embodiment, the processing unit is configured to translate the tilt into a position of a cursor on a display. In another embodiment, the processing unit is configured to translate the tilt into a motion speed of a cursor on a display. In an example embodiment, the processing unit is configured to translate the tilt into a change in motion speed of a cursor on a display. In an embodiment, the processing unit is configured to translate the tilt into the change in the motion speed by applying to the tilt a scale factor that depends on the shift in the imprint.

In some embodiments, the processing unit is configured to activate at least some of the circuitry of the input device only upon detecting that the finger is in contact with the touch surface. in an embodiment, the processing unit is configured to calculate the tilt by measuring imprints of multiple fingers simultaneously on the touch surface. In another embodiment, the processing unit is further configured to calculate a rotation of the finger about an axis of the finger based on the imprint. In yet another embodiment, the processing unit is configured to calculate both an elevation component and an azimuth component of the tilt.

There is additionally provided, in accordance with an embodiment of the present invention, a method for accepting user input. The method includes sensing an imprint of a finger on a surface of a touch sensor. A tilt of the finger relative to the surface is calculated by measuring a shift of the sensed imprint. An output is produced based on the tilt.

There is also provided, in accordance with an embodiment of the present invention, a system including a display screen, an input device and a processor. The input device includes a touch sensor, which has a surface and is configured to sense an imprint of a finger that touches the surface, and a processing unit, which is configured to calculate a tilt of the finger relative to the surface by measuring a shift of the imprint sensed by the touch surface, and to produce an output based on the tilt. The processor is configured to display a cursor on the display screen responsively to the output produced by the input device.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a laptop computer comprising an input device based on finger tilt detection, in accordance with an embodiment of the present invention;

FIG. 2 is a block diagram that schematically illustrates elements of a tilt sensor device, in accordance with an embodiment of the present invention;

FIG. 3A is an illustration of a circular layout of capacitive-based sensors in a touch surface device, in accordance with an embodiment of the present invention;

FIG. 3B is an illustration of a Cartesian layout of capacitive-based sensors in a touch surface device, in accordance with another embodiment of the present invention;

FIG. 4A is an illustration of a finger contacting a touchpad with an initial tilt vector T₀, in accordance with an embodiment of the present invention;

FIG. 4B is an illustration of a finger imprint corresponding to tilt vector T₀, in accordance with an embodiment of the present invention;

FIG. 5A is an illustration of a finger contacting a touchpad with a tilt vector T₁, in accordance with an embodiment of the present invention;

FIG. 5B is an illustration of a finger imprint corresponding to tilt vector T₁, in accordance with an embodiment of the present invention;

FIG. 6A is an illustration of a finger contacting a touchpad with a tilt vector T₂, in accordance with an embodiment of the present invention;

FIG. 6B is an illustration of a finger imprint corresponding to tilt vector T₂, in accordance with an embodiment of the present invention;

FIG. 7 is an illustration of a method for evaluating a speed adjustment coefficient A(x) for a circular sensor array, in accordance with an embodiment of the present invention; and

FIG. 8 is a flow chart that schematically illustrates a method for detecting finger tilt in a tilt sensor, in accordance with an embodiment of the present invention.

### DETAILED DESCRIPTION OF EMBODIMENTS

### Overview

In some electronic systems, a pointing device is used as a human interface to translate mechanical motion of the pointing device created by the user into position or speed information that is transmitted by the pointing device into the system. Examples of pointing devices comprise a personal computer mouse that translates the position information of the mouse into cursor location and movements on a computer display, or a track point that is similar to a mouse but is physically embedded into the electronic system.

Embodiments of the present invention that are described hereinbelow provide improved input devices and associated methods. The disclosed techniques detect a tilt of a user's finger contacting a touch surface device. The pivoting of the finger about the contact point of the finger with the touch surface device produces a “joystick effect.” In one embodiment, finger tilt is detected by sensing the movement of the finger imprint on the touch surface as the finger is pivoted around the contact point. The detected changes in finger tilt are translated to cursor position or speed.

Tilt sensors of this sort may be implemented in various computers and other electronic devices comprising touch surfaces, such as a laptop computer, a personal digital assistant, a tablet computer, a smart-phone or a portable navigation device.

The finger-tilt-based input devices described herein provide high-sensitivity, high-resolution input. At the same time, since these input devices are based on finger tilt rather than finger displacement, they can be implemented in a very small area, comparable with the area of a fingertip.

Tilt detection using the disclosed techniques can be carried out using a wide variety of touch sensors, such as touchpads implemented in laptop computers, touchscreens implemented in smartphones, to mention just a few examples. Moreover, since the disclosed tilt detection techniques require only a very small sensor area, on the order of the area of a fingertip, they can be carried out with small-area touch sensors and are particularly suitable for small-area applications.

### System and Tilt Sensor Description

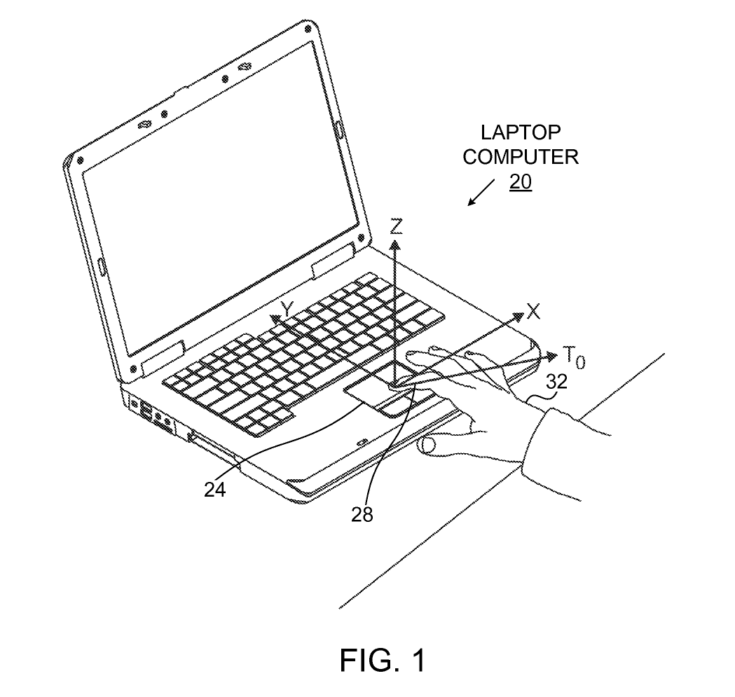

FIG. 1 is a schematic, pictorial illustration of a laptop computer 20 comprising an input device based on finger tilt detection, in accordance with an embodiment of the present invention. In the embodiment of FIG. 1, a finger tilt sensor is implemented in laptop computer 20 using a touchpad 24, which is the touch surface device for the laptop computer. A finger 28 of a user's hand 32 contacts touchpad 24 of laptop computer 20 with a certain tilt angle. Finger tilt, or tilt for brevity, is defined in the present context as the angle of tilt vector T₀, which passes axially through the distal phalanx of finger 28 and through the contact point with touchpad 24, in the Cartesian coordinate system X, Y, and Z of touchpad 24.

The X-Y plane at Z=0 in the drawing is the plane of touchpad 24 with the Z axis normal to the surface of the touchpad. The tilt angle is typically three-dimensional, e.g., comprising an elevation component (for example, the angle between T₀ and the Z axis, or between T₀ and the X-Y plane) and an azimuth component (for example, the angle between the projection of T₀ on the X-Y plane and the Y axis).

Computer 20 comprises a display screen and a processor (not shown in the figure). The processor accepts an output that is produced by the tilt sensor and is dependent on the tilt of finger 28. The processor displays a cursor on the display screen based on this output, i.e., based on the finger tilt.

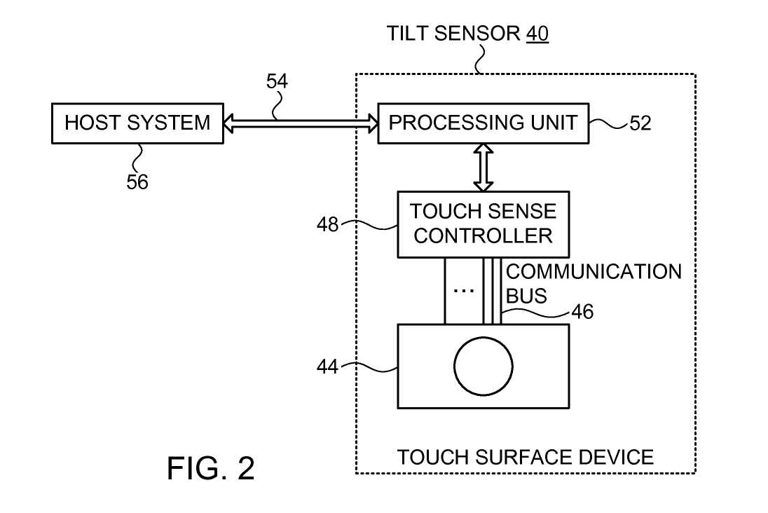

FIG. 2 is a block diagram that schematically illustrates elements of a tilt sensor device 40, in accordance with an embodiment of the present invention. Tilt sensor 40 comprises a touch surface device 44, a touch sense controller 48, and a processing unit 52. In some embodiments, tilt sensor 40 is implemented in computer 20, in which case touchpad 24 (FIG. 1) may be used as touch surface device 44.

Information about the tilt of a finger is obtained by sensing the position and movement of the finger imprint in contact with touch surface device 44. This information is processed and communicated by processing unit 52 across an interface 54 to a host system 56 (e.g., to a processor of computer 20). Interface 54 may comprise any suitable interface type.

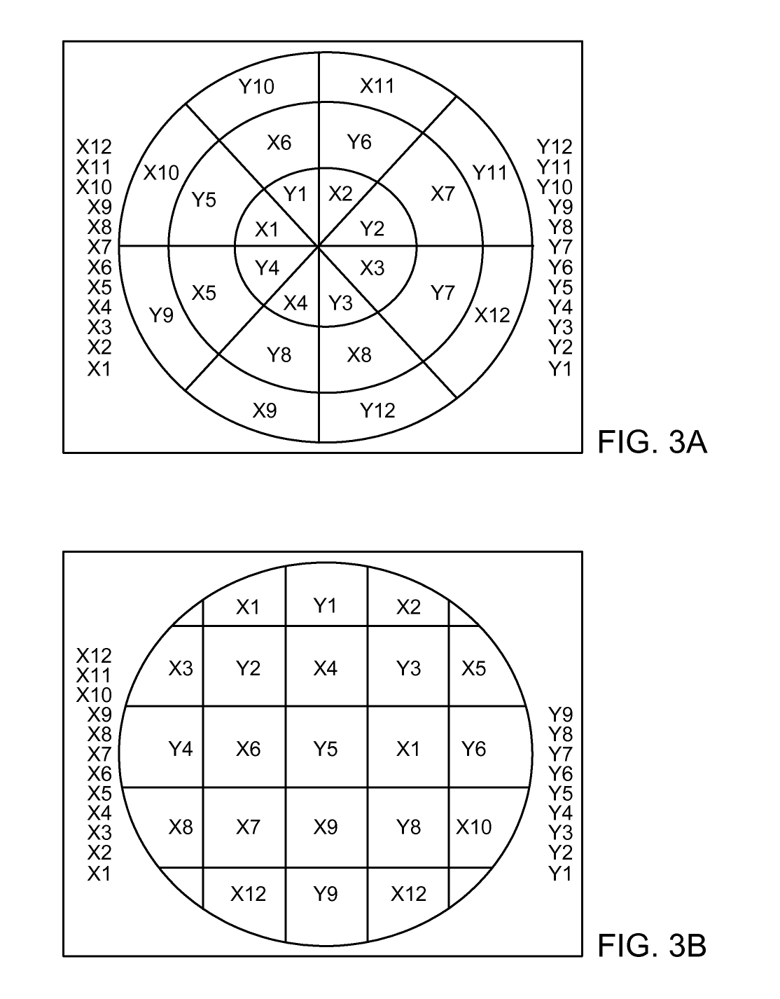

Touch surface device 44 comprises an array of sensors beneath the touch surface. Depending on the sensor technology implemented, different embodiments can comprise different arrangements of sensors. In one embodiment, the sensors may utilize, for example, capacitive sensor technology where an array of conductors are arranged in a matrix of horizontal and vertical conductor stripes whereby contact with the surface by the finger changes the capacitance of the stripes experiencing the local contact by the fingertip. In some embodiments, an array of sensors may also be implemented by a group of discrete sensors arranged in triangles, squares, hexagons, or other types of polygons. Example sensor configurations are shown in FIGS. 3A and 3B below.

Upon contact, the change in the capacitance at each sensor is detected by touch sense controller 48 through a communication bus 46 interfacing with touch surface device 44. Touch sense controller 48 comprises circuitry to convert the information on communication bus 46 comprising an electrical indication of the change in capacitance at each individual sensor in the array to digital information, which is transmitted to processing unit 52. Examples of capacitance-based touch sensing schemes that can be used for implementing touch surface device 44 are described in U.S. Pat. Nos. 7,797,115 and 7,945,399, whose disclosures are incorporated herein by reference. Alternatively, any other suitable sensor technology can be used.

The configuration of tilt sensor 40 shown in FIG. 2 is an example configuration, which is chosen purely for the sake of conceptual clarity. In alternative embodiments, any other suitable configurations can be used. The functions of the various tilt sensor elements can be implemented in hardware, in software, or using a combination of hardware and software elements.

In some embodiments, certain tilt sensor functions (e.g., functions of processing unit 52) are implemented in a programmable processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory. In some embodiments, certain system elements may be integrated or their functionality partitioned differently than the configuration shown in FIG. 1. For example, processing unit 52 of tilt sensor 40 and host system 56 can be integrated in one unit.

FIGS. 3A and 3B are illustrations of a circular layout and a Cartesian layout, respectively, of capacitive-based sensors in a touch surface device, in accordance with embodiments of the present invention. In FIG. 3A, the discrete array comprises a sliced circle configuration of discrete capacitive sensors. In FIG. 3B, the array comprises a Cartesian configuration of discrete capacitive sensors. Typically, each of the discrete sensors may have its own identifier such as X1, X2, X3 . . . or Y1, Y2, Y3 . . . as shown in FIG. 3A and FIG. 3B. The touch surface device comprises a plurality of contacts forming a communication bus connecting each of the capacitive sensors in the array to touch sense controller 48.

The spatial density of the sensors in touch surface device 44 determines the resolution with which the position of the finger imprint can be detected on the surface of touchpad 24. In one embodiment, the area of the sensing array for detecting finger tilt is on the order of 15 mm×15 mm. In accordance with the example embodiments shown in FIGS. 3A and 3B, the diameter of the sensing arrays is 18 mm. In FIG. 3A, the radii of the three concentric circles defining the sensors are 5.2 mm, 7.35 mm and 9 mm. The array configurations shown in FIGS. 3A and 3B are depicted purely by way of example. In alternative embodiments, any other suitable array configuration and dimensions can be used.

### Tilt Detection

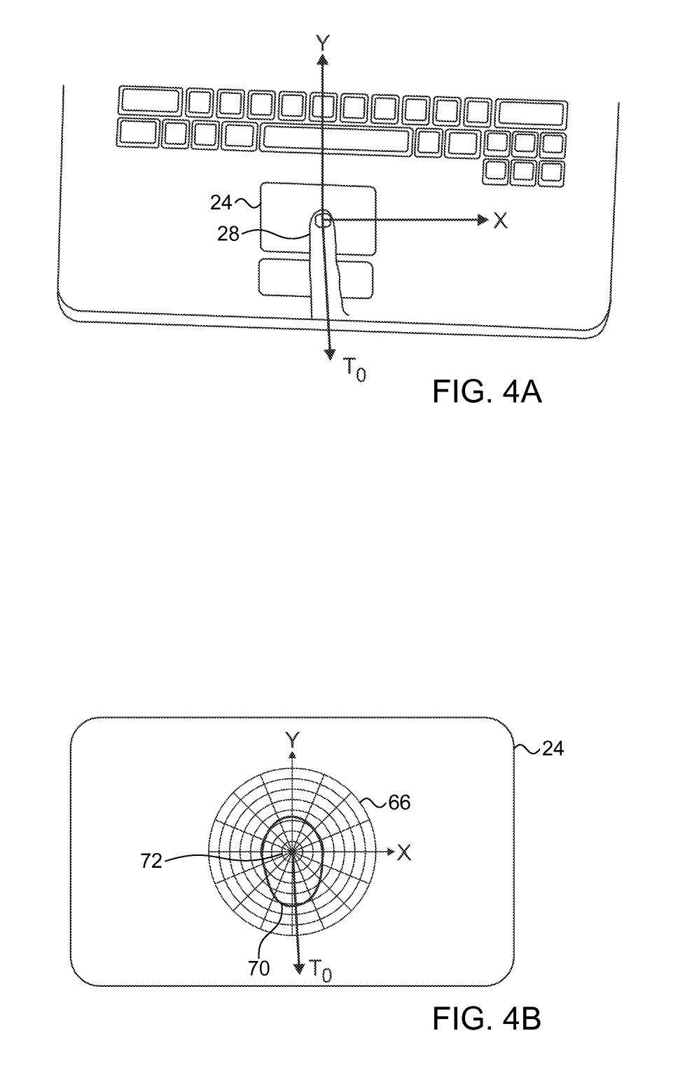

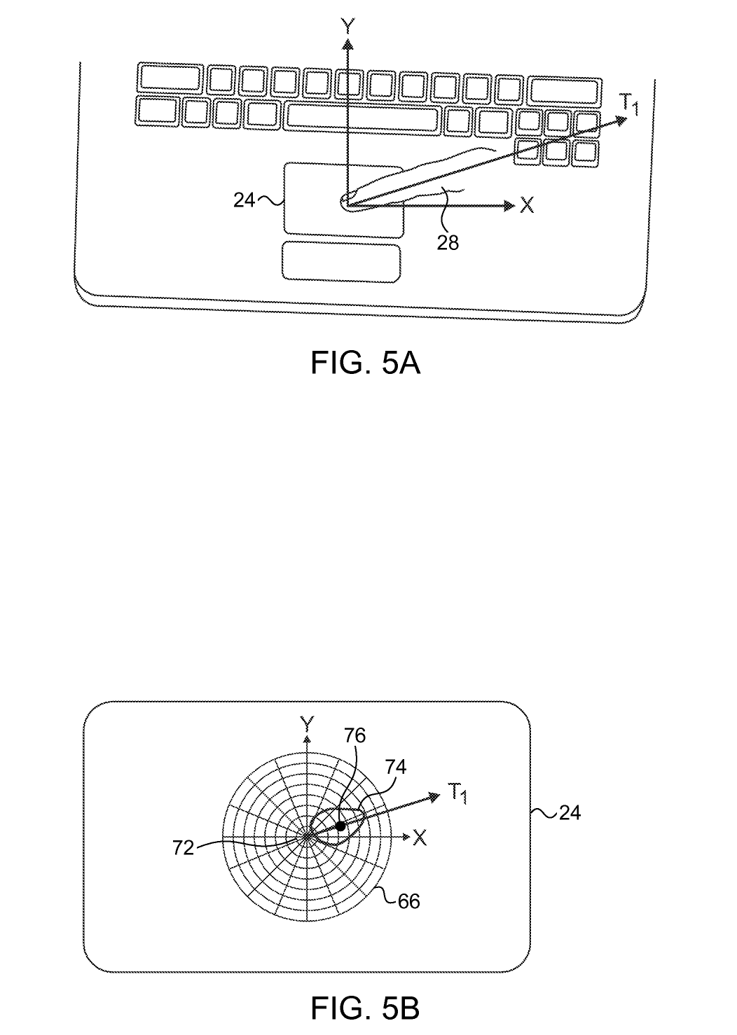

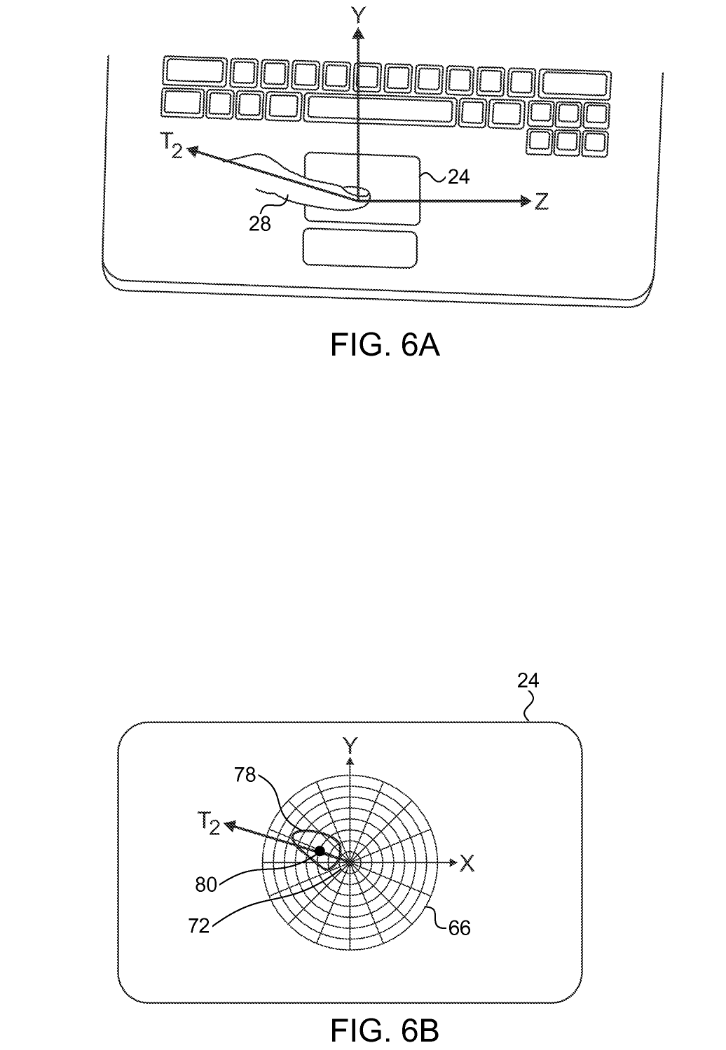

FIGS. 4A and 4B are illustrations of finger 28 contacting the touch surface device, in the present example touchpad 24, with an initial tilt vector T₀, and of an imprint 70 of the finger on the touchpad, in accordance with an embodiment of the present invention. FIG. 4A (as well as in FIGS. 5A and 6A below) show only finger 28 and not the rest of the user's hand, to emphasize that the tilt detection schemes described herein generally detect finger tilt alone and are insensitive to other movements, e.g., palm movements.

Touchpad 24 comprises a sensor array 66. When finger contacts sensor array 66, the finger creates finger imprint 70 that contacts different sensor elements within sensor array 66. The sensing regions within sensor array 66 are shown in FIG. 4B as a circular grid chosen only for the sake of conceptual clarity in the present embodiment. The term “finger imprint” refers to the region on the touch sensor device, e.g., touchpad 24 as shown in FIG. 4A that is in contact with finger 28, as detected by the sensors of array 66.

When finger 28 initially contacts the touch surface device, e.g., touchpad 24, tilt sensor 40 defines a finger imprint center of motion 72, which is then used by the tilt sensor for processing tilt movement. The center of motion is typically defined as the average, e.g., centroid, of imprint 70, which is created when the user first touches the touchpad anywhere on its surface. For the embodiment shown in FIG. 4B (although not necessarily), center of motion 72 is at the center (origin) of sensor array 66.

When the user places finger 28 initially on touchpad 24, the tilt orientation of the finger relative to the plane of the touchpad is sensed by touchpad 24 as finger imprint 70 corresponding to tilt vector T. Touch sense controller 48 of tilt sensor 40 transmits touch surface device data of finger imprint 70 to processing unit 52. If the user's finger is removed from the touch surface device and then replaced anywhere on the touch surface device, information about the finger imprint center of motion is reset in the tilt sensor.

FIGS. 5A and 5B are illustrations of finger 28 contacting touchpad 24 with a subsequent tilt vector T₁, and of an imprint 74 of the finger on the touchpad, in accordance with an embodiment of the present invention. As finger 28 is tilted upward and to the right on touchpad 24, the tilt vector of the finger changes from T₀ to T₁. Finger imprint 74, corresponding to tilt vector T₁, not only moves in the same direction, but a center 76 of finger imprint 74 is also displaced upward and to the right as shown in FIG. 5B, away from finger imprint center of motion 72 in sensor array 66.

FIGS. 6A and 6B are illustrations of finger 28 contacting touchpad 24 with a tilt vector T₂, and of an imprint 78 of the finger on the touchpad, in accordance with an embodiment of the present invention. Similarly, as finger 28 is tilted upward and to the left on touchpad 24, a resultant tilt vector T₂ is shown in FIG. 6A. Finger imprint 78 corresponding to tilt vector T₂ is shown in FIG. 6B. A center 80 of finger imprint 78 moves upward and to the left away from finger imprint center of motion 72 in sensor array 66 as the tilt vector of the finger changes from T₀ to T₂.

In some embodiments, processing unit 52 identifies the change in the tilt of finger 28 (change from T₀ to T₁, or from T₀ to T₂) by comparing the respective finger imprints (imprint 74 to imprint 72, or imprint 78 to imprint 72). For example, processing unit 52 may resolve the tilt motion by comparing the coordinates of finger imprint 74 to finger imprint center of motion 72, or by comparing the coordinates of finger imprint 78 to finger imprint center of motion 72. In some embodiments, processing unit 52 can identify the change in the tilt of the finger by comparing any arbitrary point or area within the finger imprint, such as the edges of the finger imprint, relative to any arbitrary point or area of the within the finger imprint when the finger initially contacts the touch surface device, which sets the finger imprint center of motion as defined by the tilt sensor.

### Translation of Finger Tilt into Cursor Movement

Processing unit 52 typically translates the detected finger tilt into cursor movements on the display of host system 56 (e.g., computer 20). Typically, processing unit reports the corresponding cursor movement to host system 56 over the interface between them.

In some embodiments, processing unit 52 translates a given change in tilt to a corresponding change in cursor position on the display. In alternative embodiments, processing unit 52 translates a given change in tilt to a corresponding change in cursor speed.

As explained above, in some embodiments the tilt sensor detects the finger imprint position relative to the finger imprint center of motion. The larger the distance that the position of the finger imprint is from the finger imprint center of motion, the larger the required cursor movement or speed.

In some embodiments, the tilt sensor can implement the behavior of a joystick to move a cursor on the display of a computer. When the finger contacts the touch surface device, such as a touchpad, with initial tilt vector T₀, but is not tilted about the contact point, whereas there is no change in T₀, the cursor does not move. However, if the finger is tilted about the contact point to some arbitrary tilt vector T, the cursor starts to move on the display screen with a speed that depends of the change of the angular difference between the tilt vectors T₀ and T. The larger the angular difference between the tilt vectors T₀ and T, the higher the cursor speed.

If the finger tilt remains fixed at T, the cursor speed will remain constant. The cursor will decelerate and stop moving only when the finger is moved from T back to the position of tilt vector T₀ as defined by the initial contact of the finger with the touchpad. The change in tilt is detected by the movement of the finger imprint on the touchpad as the finger imprint corresponding to tilt vector T moves relative to the finger imprint center of motion corresponding to tilt vector T₀ as previously described. Thus, the disclosed techniques can be viewed as translating tilt into motion speed of the cursor, or into acceleration (change in motion speed) of the cursor.

With reference to the Cartesian coordinates (X,Y,Z) relative to touchpad 24 and the definition of tilt vector as shown in FIGS. 1, 4A, and 4B, each instance that the user places finger 28 on touchpad 24, the finger imprint center of motion is assigned coordinates (X,Y)=(0,0) on the touchpad plane at Z=0.

Each time the user tilts finger 28 on the touch surface device after the finger imprint center of motion (0,0) is defined, the tilt sensor reports a number of different tilt data metrics to host system 56, which in some embodiments can comprise the finger imprint position (X′,Y′), the motion speed of the finger imprint position (X′,Y′) relative to the finger imprint center of motion (0,0), distance dependent parameters (dX,dY) as described below, as well as other tilt parameters related to finger position, motion speed and motion acceleration in the tilt sensor.

In some embodiments, the distance dependent parameters (dX,dY) are computed by processing unit 52 using the equations:

dX=CoefX*A(DIST) and dY=CoefY*A(DIST) (1)

where DIST, A(DIST), CoefX, and CoefY factors are calculated by processing unit 52 in accordance with the following steps:

Step 1: Calculation of the current position of the new finger imprint (X′,Y′) on touchpad plane Z=0 after the user tilts finger 28.

Step 2: The geometric distance DIST between the new finger imprint position at (X′,Y′) and the finger imprint center of motion at (0,0) is calculated by:

DIST=\sqrt{X′²+Y′²} (2)

Step 3: The distance dependent coefficients for dX and dY are given by:

CoefX=X′/DIST and CoefY=Y′/DIST (3)

Step 4: Calculation of the speed adjustment coefficient A(DIST) used in Equation (1). This coefficient gives higher mathematical weight to the speed of the finger imprint moving on the plane of the touch surface device to the finger imprint positions that are further away from the finger imprint center of motion, and is related to tilt acceleration. As described in an earlier embodiment, for a large angular difference between finger tilt vectors T and T₀ created by the user corresponding to finger imprint positions (X′,Y′) and (0,0), respectively, the distance between finger imprint position (X′,Y′) relative to the finger imprint center of motion (0,0) may actually be small. However, (dX,dY) values can be very large to account for the large angular difference between finger tilt vectors T and T_{O} due to compensations made by the speed adjustment coefficient A(DIST) as defined in Equation (1).

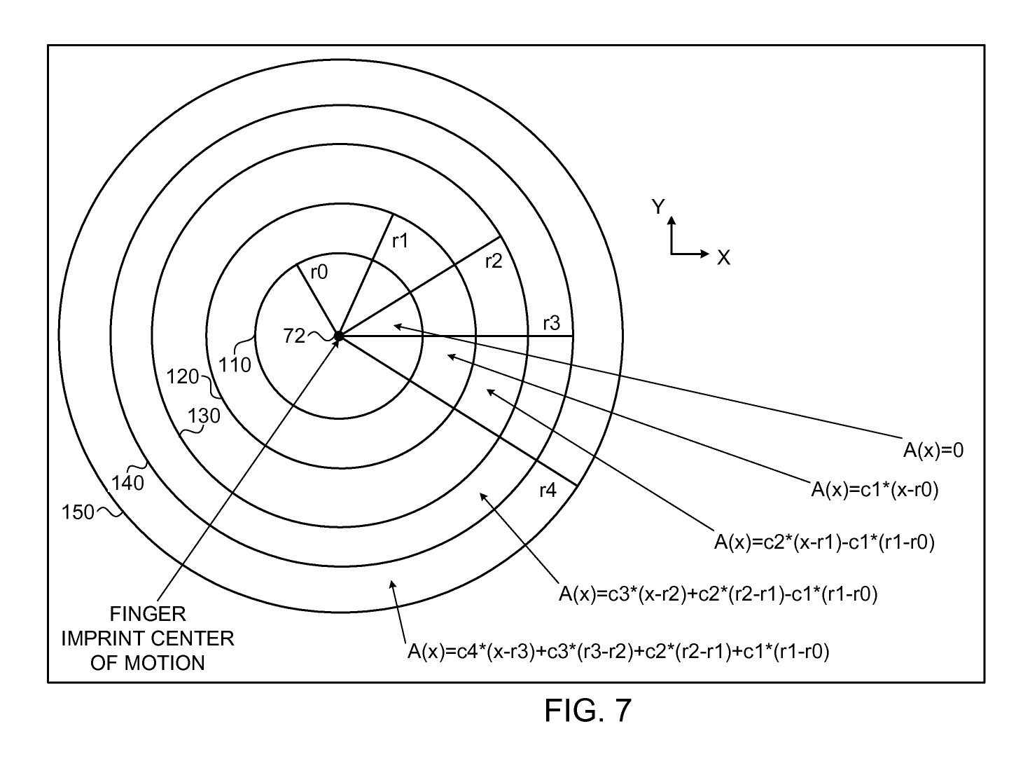

FIG. 7 is an illustration of a method for evaluating coefficient A(x) for a circular sensor array, in accordance with an embodiment of the present invention. In some embodiments, the speed adjustment coefficient A(x) where x=DIST is given by the mathematical model:

$$A ( x ) = \{ \begin{matrix}0 & if x < r 0 \\ ( x - r 0 ) * c 1 & if r 0 \leq x < r 1 \\ ( x - r 1 ) * c 2 + & if 1 r \leq x < 2 r \\ ( r 1 - r 0 ) * c 1 & \\ ( x - r 2 ) * c 3 + & if r 2 \leq x < 3 r \\ ( r 2 - 1 r ) * c 2 + & \\ ( r 1 - r 0 ) * c 1 & \\ ( x - r 3 ) * c 4 + & if r 3 \leq x \\ ( r 3 - r 2 ) * c 3 + & \\ ( r 2 - r 1 ) * c 2 + & \\ ( r 1 - r 0 ) * c 1 & \end{matrix} \qquad ( 4 )$$

where r0, r1, r2, r3, r4 are distance constants such that r0<r1<r2<r3<r4 and c1, c2, c3, c4 are predetermined coefficients.

For this particular embodiment, the number of distance constants is five corresponding to the radial distances bounding five circular regions as measured radially away from finger imprint center of motion 72 in a circular touch sensor array as shown in FIG. 7. The first sensor region is bounded by a ring 110 with radius r0. Similarly, the next four sensor regions with radii r1, r2, r3, and r4 correspond to ring 120, ring 130, ring 140, and ring 150, respectively. Representative values for the distance coefficients r0, r1, r2, and r3 are 1 mm, 5 mm, 10 mm, and 20 mm, respectively, whereas representative values for the predetermined coefficients c1, c2, c3, and c4 are 1, 2, 3, and 4, respectively. The circular sensing regions shown in FIG. 7 and the number of circular sensing regions are shown here by way of example, and may vary in other implementations.

In another embodiment of the present invention, the speed adjustment coefficient A(x) where x=DIST is given by the mathematical model:

$$A ( x ) = \{ \begin{matrix}0 & if x < r 0 \\ {( x - r 0 )}^{b} * c & if r 0 \leq x\end{matrix} \qquad ( 5 )$$

where r0 is a distance constant, and where b and c are predefined coefficients.

In another embodiment of the present invention, the speed adjustment coefficient A(x) where x=DIST is given by the mathematical model:

$$A ( x ) = \{ \begin{matrix}0 & if x < r 0 \\ a * ( x - r 0 ) + b * {( x - r 0 )}^{2} & if r 0 \leq x\end{matrix} \qquad ( 6 )$$

where r0 is a distance constant, and where a and b are predefined coefficients.

In other embodiments, the speed adjustment coefficient A(DIST) used in Equation (1), which converts the position of the finger imprint relative to the finger imprint center of motion into position, motion speed, and acceleration could be the outcome of a linear function, a piecewise linear function, a nonlinear function or combination thereof, all of which are dependent on the geometric distance DIST as previously defined.

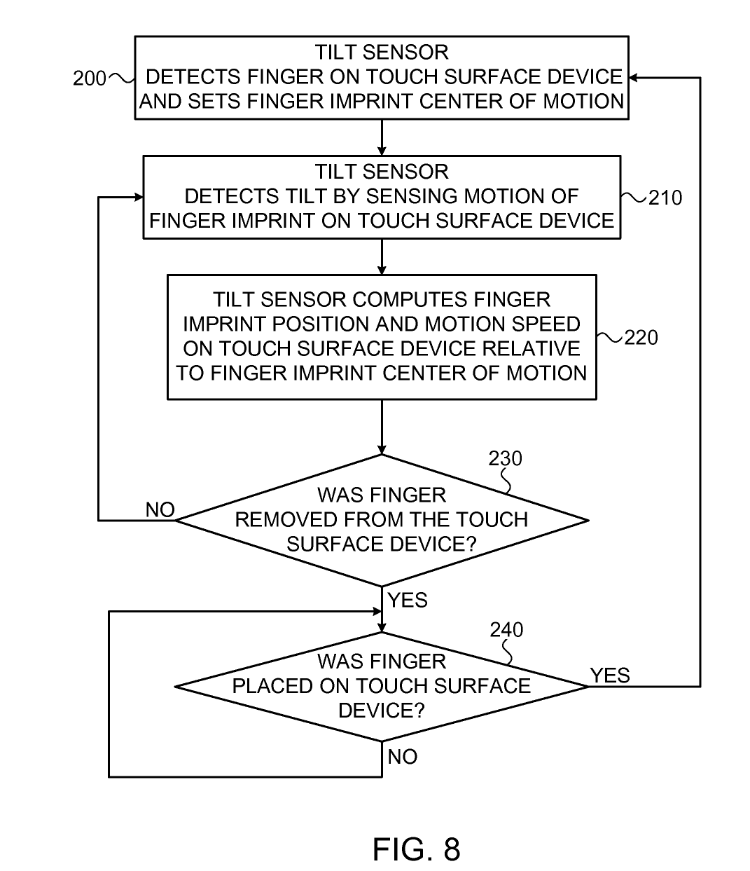

FIG. 8 is a flow chart that schematically illustrates a method for detecting finger tilt, in accordance with an embodiment of the present invention. At an initial detection step 200, tilt sensor 40 detects finger 28 of the user on touch surface device 44, such as a laptop touchpad. Processing unit 52 relays the position of the finger imprint center of motion to host system 56.

At a tilt detection step 210, tilt sensor 40 detects the tilt of finger 28 by sensing the motion of the finger imprint on touch surface device 44. At a change computation step 220, processing unit 52 computes finger imprint position and motion speed relative to the finger imprint center of motion corresponding to a change in the finger tilt on the touch surface device. The processing unit then reports the finger tilt metrics in accordance with the embodiments of the present invention described herein to the host system.

If the finger was removed from the touch surface, as checked at removal checking step 230, the tilt sensor then checks at a re-placement step 240 if the finger was placed back on the surface and if so, the tilt sensor resets the position of the finger imprint center of motion. If the finger was not removed from the touch surface device, the tilt sensor continues to sense motion of the finger imprint as an indicator of tilt motion.

### Other Embodiments of the Tilt Sensor

In other embodiments, the tilt sensor can also be configured such that the finger imprint center of motion is the physical geometric center of the touch surface device.

In some embodiments of the tilt sensor, a power management mechanism to substantially reduce current consumption by the tilt sensor circuitry can be implemented whereby the devices comprising the tilt sensor are kept inactive or idle until finger placement on the touch surface device is detected. The tilt sensor checks periodically for finger placement in a predetermined period of time.

In other embodiments, the tilt sensor can be configured to detect a twisting motion of the finger on the touch surface device, i.e., a rotation of the finger about its axis, by which the user indicates direction and speed obtained by the extent of the twisting motion.

In some embodiments, a tilt sensor can be implemented using an existing touchpad or touch-based pointing device whereby a firmware or software upgrade is provided to the user which adds tilt sensing functionality to the existing hardware.

In other embodiments, a touch surface device comprising a large area can be implemented whereby multiple touch points by more than one finger are detected. The finger imprint center of motion is computed from the geometric center of the multiple touch points. The movement of the multiple finger imprints relative to the finger imprint center of motion can be converted to motion speed in accordance with the embodiments of the prevent invention previously described herein.

Although the embodiments described herein refer mainly to measuring tilt by detecting a shift in the center of the finger imprint, the tilt may alternatively be measured by detecting any other suitable kind of shift of the finger imprint, for example a shift in the imprint edge.

Although the embodiments described herein mainly address tilt detection in capacitive-based, planar touch surface track point devices, the methods and systems described herein can also be used in other applications in which a tilt sensor could be implemented using other touch-sensing technologies, such as optical touch sensing and resistive touch sensing.

Moreover, the disclosed techniques are not limited to a planar touch surface device. The touch surface device can be arched and bowed upward over a flat surface, or concave and bowed inward within a larger flat surface. The touch surface device could comprise a flexible touch surface, or rigid touch surface. The touch surface device can be a stand-alone unit, or can be defined as a pre-defined region within a larger touch surface. Touchpads, touch panels, touch screens, or any other touch sensitive device comprising a designated region for sensing the movement of a finger imprint, are herein regarded as touch surface devices, which can be implemented in tilt sensors.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An input device, comprising:
a touch sensor, which has a surface and is configured to sense an imprint of a finger that touches the surface; and
a processing unit, which is configured to calculate a tilt of the finger relative to the surface by measuring a shift of the imprint sensed by the touch surface, and to produce an output based on the tilt.

2. The input device according to claim 1, wherein the processing unit is configured to measure the shift in the imprint between a first time at which the finger initially touches the surface and a second time that is subsequent to the first time.

3. The input device according to claim 1, wherein the processing unit is configured to measure the shift in the imprint by measuring a displacement of a center of the imprint.

4. The input device according to claim 1, wherein the processing unit is configured to translate the tilt into a position of a cursor on a display.

5. The input device according to claim 1, wherein the processing unit is configured to translate the tilt into a motion speed of a cursor on a display.

6. The input device according to claim 1, wherein the processing unit is configured to translate the tilt into a change in motion speed of a cursor on a display.

7. The input device according to claim 6, wherein the processing unit is configured to translate the tilt into the change in the motion speed by applying to the tilt a scale factor that depends on the shift in the imprint.

8. The input device according to claim 1, wherein the processing unit is configured to activate at least some of the circuitry of the input device only upon detecting that the finger is in contact with the touch surface.

9. The input device according to claim 1, wherein the processing unit is configured to calculate the tilt by measuring imprints of multiple fingers simultaneously on the touch surface.

10. The input device according to claim 1, wherein the processing unit is further configured to calculate a rotation of the finger about an axis of the finger based on the imprint.

11. The input device according to claim 1, wherein the processing unit is configured to calculate both an elevation component and an azimuth component of the tilt.

12. A method for accepting user input, comprising:
sensing an imprint of a finger on a surface of a touch sensor;
calculating a tilt of the finger relative to the surface by measuring a shift of the sensed imprint; and
producing an output based on the tilt.

13. The method according to claim 12, wherein calculating the tilt comprises measuring the shift in the imprint between a first time at which the finger initially touches the surface and a second time that is subsequent to the first time.

14. The method according to claim 12, wherein measuring the shift comprises measuring a displacement of a center of the imprint.

15. The method according to claim 12, wherein producing the output comprises translating the tilt into a position of a cursor on a display.

16. The method according to claim 12, wherein producing the output comprises translating the tilt into a motion speed of a cursor on a display.

17. The method according to claim 12, wherein producing the output comprises translating the tilt into a change in motion speed of a cursor on a display.

18. The method according to claim 17, wherein translating the tilt into the change in the motion speed comprises applying to the tilt a scale factor that depends on the shift in the imprint.

19. The method according to claim 12, and comprising activating at least some of the circuitry of the input device only upon detecting that the finger is in contact with the touch surface.

20. The method according to claim 12, wherein calculating the tilt comprises measuring imprints of multiple fingers simultaneously on the touch surface.

21. The method according to claim 12, and comprising calculating a rotation of the finger about an axis of the finger based on the imprint.

22. The method according to claim 12, wherein calculating the tilt comprises calculating both an elevation component and an azimuth component of the tilt.

23. A system, comprising:
a display screen;
an input device, comprising:
a touch sensor, which has a surface and is configured to sense an imprint of a finger that touches the surface; and
a processing unit, which is configured to calculate a tilt of the finger relative to the surface by measuring a shift of the imprint sensed by the touch surface, and to produce an output based on the tilt; and
a processor, which is configured to display a cursor on the display screen responsively to the output produced by the input device.
